(19) United States
(12) Patent Application Publication
(10) Pub. No.: US 2011/0100918 A1
(43) Pub. Date: May 5, 2011

(54) WATER PURIFIER DIRECTLY CONNECTED TO FAUCET

(76) Inventors: Hak-Sub Shim, Seoul (KR); Duk-Soo Lee, Seoul (KR)

(21) Appl. No.: 12/673,533

(22) PCT Filed: Aug. 11, 2008
(86) PCT No.: PCT/KR08/04667

§ 371 Date: Feb. 15, 2010

(30) Foreign Application Priority Data
Aug. 17, 2007 (KR) 10-2007-0083011

(51) Int. Cl. C02F 1/62; B01D 35/02; C02F 9/02

(52) U.S. Cl. 210/667; 210/201; 210/665; 210/199

(57) ABSTRACT

The present invention relates to a water purifier of tap water. According to the present invention, a metal having a higher ionization tendency is ionized by exposing the metal to water to be purified. The metal having a higher ionization tendency is selected based on iron (Fe) and limited to metals having a higher ionization tendency as compared with iron (Fe). Electrons generated when a metal is ionized into water react with heavy metal ions that have already existed in the water to reduce the heavy metal ions. The heavy metal ions react with the electrons and are converted into heavy metal components. The heavy metals are pulled by magnets with a strong magnetism and removed from the water safely. When using a water purifier according to the present invention, users can drink water useful to the human body safely and hygienically since mineral components dissolved into water are not removed at all while removing the heavy metals although small quantities of heavy metals are dissolved into water.

### TECHNICAL FIELD

The present invention relates to a water purifier of tap water, and more particularly, to a water purifier directly connected to a faucet, which is directly connected to a water pipe to remove heavy metals and harmful substances in tap water and to add mineral components to the tap water at the same time.

### BACKGROUND ART

Ingestion of water in the human life is one of important living elements. After men started living cultural lives, they have experienced the industrialization process and have utilized a large amount of water required in the industrialization as industrial water. Such industrial water has necessarily caused problems of environmental pollution, and a number of efforts are being conducted to redress the problems.

Although contemporary industrial advancement improves quality of the life by making lives of the men convenient and abundant, the contemporary industrial advancement provides side effects such as various kinds of pollution and environmental pollution problems at the same time. The most severe problem in the various kinds of the environmental pollution is contamination of a water supply source and supply of stable and hygienic water.

The contamination of the water supply source has been mainly generated by domestic wastewater and various kinds of sewage and wastewater discharged from plants, livestock farmhouses, and the like. Such contamination problem of the water supply source is being solved to a certain extent by disapproving the construction of plants on an area of the water supply source and improving facilities of the livestock farmhouses. Furthermore, the contamination problem of the water supply source is solved by establishing a system for supplying households with filtered and sterilized water after filtering and sterilizing water or by establishing a reservoir at a large purification plant.

In the meantime, various water pipes are used to stably supply citizens with tap water that has been cleanly filtered and sterilized at the purification plant. However, there is a contamination problem of tap water caused by deterioration and corrosion of the water pipes. This means that it is difficult to drink the tap water flowing into the households through the water pipes as it is although the tap water is produced as first grade water at the purification plant and then supplied to the households.

Therefore, users hardly drink the tap water as it is at households, offices, and the like. The users buy and drink natural mineral waters or drink the purified tap water after purifying the tap water using various types of water purifiers.

However, current generalized water purifiers have a disadvantage that the water purifiers cannot completely remove various heavy metal components dissolved into the tap water. The water purifiers do not have mechanisms that are capable of fundamentally eliminating the heavy metal components since the various heavy metal components generally exist in the form of ions.

Meantime, a conventional water purifier comprises a reverse osmosis system to remove such heavy metal components. However, although a reverse osmosis type water purifier has an advantage of removing heavy metal components dissolved into tap water, it has a disadvantage in that small amounts of mineral components essentially dissolved into water are also removed together with the heavy metal components at the same time.

As described above, various water purifiers generally used today have disadvantages that heavy metal components existing in the form of various ions cannot completely removed, and various mineral components useful to the human body are removed together with the heavy metal components at the same time although the heavy metal components are removed by the water purifiers.

### DISCLOSURE OF INVENTION

### Technical Problem

An object of the present invention is to provide a water purifier directly connected to a faucet, which is directly connected to a water pipe to remove heavy metals and harmful substances in tap water and maintain mineral components in the tap water as they are.

Further, another object of the present invention is to provide a water purifier directly connected to a faucet, which is directly connected to a water pipe to remove heavy metals and harmful substances in tap water and further add natural mineral components in filtered tap water at the same time.

Moreover, a further object of the present invention is to provide a water purification method of a water purifier directly connected to a faucet, in which a water purifier is directly connected to a water pipe to remove heavy metals and harmful substances in tap water and maintain mineral components in the tap water as they are.

### Technical Solution

A water purifier according to the present invention comprises an inflow part connected to a water pipe and allowing tap water to be introduced thereinto; an ionization part for ionizing metal components having a higher ionization tendency as compared with iron (Fe) to dissolve the metal components into the water; an activated carbon filtration part connected to the ionization part and filtering the water while the activated carbon filtration part allows the water to flow at a flow rate slower than that in the ionization part; a heavy metal removing part connected to the activated carbon filtration part and removing heavy metal components into which heavy metal ions are converted from heavy metal ions by action of the ionization part; and a discharge part for discharging heavy metal component-removed water to the outside.

Preferably, the present invention further comprises a mineral supplying part connected to the heavy metal removing part and supplying mineral components into heavy metal-removed water.

A method using a water purifier according to the present invention comprises: an ionization step of introducing tap water from a water pipe into a water purifier and ionizing metal (M) components having a higher ionization tendency as compared with iron (Fe) into the introduced tap water to dissolve the metal components into the water; a filtration step of filtering the ionized water by activated carbon while the ionized water flows slowly as compared with the ionization step; a heavy metal removing step of removing heavy metal components from the filtered water by magnetism thereof; and a discharge step of discharging heavy metal component-removed water to the outside to use it as drinking water.

Preferably, the present invention further comprises a mineral supplying step of supplying mineral components into the heavy metal-removed water after performing the heavy metal removing step.

### Advantageous Effects

The present invention has advantages in that a water purifier is used in a state where the water purifier is directly connected to tap water, and the water purifier can supply fresh water filled with vitality to modern people tired of daily lives of industrial societies by supplying mineral components into the water at the same time while removing microorganisms and heavy metal components dissolved into water.

Furthermore, the present invention can give an effect in that tap water is converted into weak acidic spring water by causing filtered water to flow through a granite powder containing large quantities of alkaline minerals such that alkaline mineral components are eluted into the water.

### BRIEF DESCRIPTION OF THE DRAWINGS

FIG. 1 is a conceptual view schematically illustrating components of a water purifier according to the present invention.

FIG. 2 is an enlarged sectional view taken along line X-X of FIG. 1.

FIG. 3 is a conceptual view illustrating a purification process of tap water by a water purifier of the present invention.

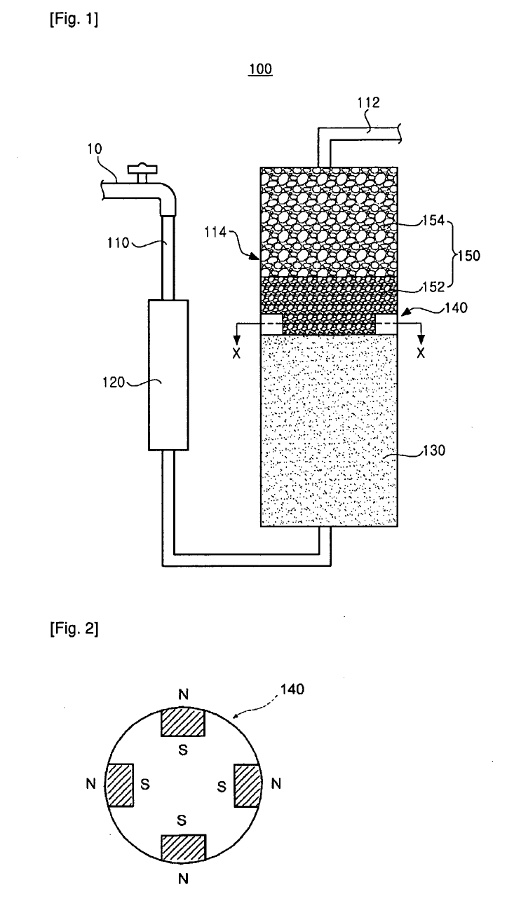

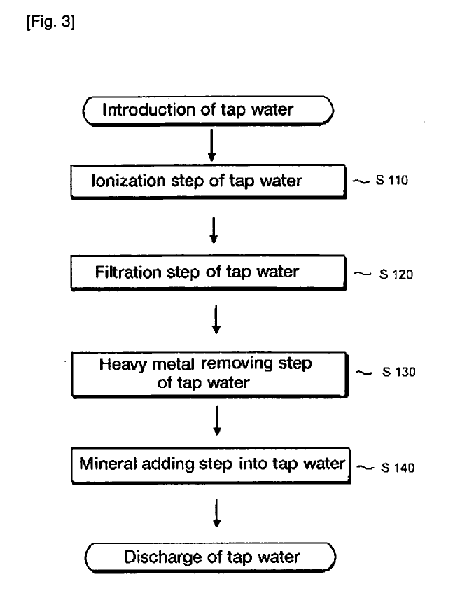

### BEST MODE FOR CARRYING OUT THE INVENTION

Hereinafter, the present invention will be described in detail with reference to the accompanying drawings. However, the drawings are only for describing the technical spirit of the present invention in more detail, and reasonably, the technical spirit of the present invention is not limited thereto.

The present invention provides a water purifier 100 directly connected to waterworks, which can be used by being directly connected to a water pipe.

The water purifier 100 according to the present invention comprises an inflow part 110, which is connected to a water pipe 10, and into which water flows. The inflow part 110 introduces tap water thereto from a pipe directly connected to the water pipe.

The water purifier 100 according to the present invention comprises an ionization part 120. According to the present invention, the ionization part 120 is a part for ionizing a metal (M) component with a higher ionization tendency to dissolve the metal (M) component into tap water which flows into the water purifier through the inflow part 110 and imparts anions (e′) into the water.

In the present invention, the metal (M) component is preferably a metal component with a higher ionization tendency as compared with iron (Fe). Since most of heavy metal components dissolved into water have lower ionization tendencies as compared with iron (Fe), the metal (M) with a higher ionization tendency is converted into monovalent ions (M⁺¹), bivalent ions (M⁺²), or trivalent ions (M⁺³), and donates one to three electrons (anions) when ionizing the metal component with a higher ionization tendency as compared with the iron (Fe) into water. On the other hand, cations of heavy metals with lower ionization tendency as compared with iron (Fe) are reduced into heavy metals by receiving the electrons (anions).

In the present invention, the metal component with a higher ionization tendency is one selected from potassium (K), calcium (Ca), sodium (Na), magnesium (Mg), aluminum (Al), and zinc (Zn), for example.

According to the present invention, zinc (Zn) is most preferable as the metal component. Although the metal (M) component with a higher ionization tendency as compared with iron (Fe) is preferable, a metal with too high ionization tendency is not preferable. When the ionization tendency of the metal (M) component is too high, it is difficult for the metal (M) component to exist as pure ions in water, but it is easy for the metal component (M) to bond to other nonmetal elements at room temperature.

Furthermore, when the metal having a higher ionization tendency is ionized, the ionized metal is essentially dissolved into water, so that the ionized metal is absorbed into the human body of a user who drinks such water that contains the ionized metal. If the metal having a higher ionization tendency is harmful to the human body, it is desirable that the metal should not be selected from the group of the ionized metal above-mentioned. Therefore it is desirable that the present invention precludes the higher ionization tendency of the metal (M) component harmful to the human body.

Further, the zinc (Zn) is selected as the most preferable ionization metal in the present invention since the zinc (Zn) is not harmful to the human body, the zinc (Zn) is a representative inorganic material that forms cells in the human body and controls a physiological function when the zinc (Zn) is absorbed into the human body, and the zinc (Zn) is a material required in the activation of an enzyme for synthesizing insulin, hexane, and protein. Furthermore, when the human body is deficient in zinc (Zn), zinc deficiency is caused, and more specifically, problems such as inappetence, growth retardation, skin eruption, and sexual dysfunction are caused.

Therefore, the present inventors have selected zinc (Zn) as the most appropriate ionization metal in consideration of the foregoing aspects.

In the present invention, the ionization part 120 allows a metal component having a high ionization tendency to be brought into direct contact with tap water. In the contact process, the friction of the metal component with water makes a zinc (Zn) component be dissolved into water and at the same time be ionized such that the zinc component exists in a state where it is separated into zinc ions (Zn⁺²) and two electrons (e⁻¹). This is represented by the following expression (I):

Zn=Zn⁺²+2e⁻¹ (I)

In the present invention, it is preferable that zinc metal and an insulator be alternately arranged and brass is formed on an outer portion thereof in the ionization part 120 in order to ionize the zinc metal better. It is preferable to allow tap water to pass by the zinc metal while causing strong friction between the tap water and the zinc metal.

The water purifier 100 according to the present invention comprises an activated carbon filtration part 130 connected to the ionization part 120.

In the present invention, the activated carbon filtration part 130 filters the water while the water flows at a flow rate slower than that in the ionization part 120. It is preferable to form the activated carbon filtration part 130 by mixing granular activated carbon with silver activated carbon. The activated carbon filtration part 130 removes residual chlorine and impurities remaining in tap water by the granular activated carbon, and sterilizes and removes microorganisms and the like existing in the tap water by the silver activated carbon. Although the tap water has been obtained by subjecting raw water to filtration and sterilization in accordance with the standard of drinking water at a purification plant, microorganisms or impurities such as scale may be produced when the tap water passes through pipe facilities connected between the purification plant and end-users such as households. Such microorganisms and impurities are removed in the activated carbon filtration part 130.

Further, it is important in the present invention to position the activated carbon filtration part 130 at a place right next to the ionization part 120 and to use the activated carbon filtration part 130 in a state where it is connected to the ionization part 120. This is because a space and time should be provided such that after zinc is separated into zinc ions. (Zn⁺²) and two electrons (e⁻¹) by ionizing zinc (Zn) while the tap water passes through the ionization part 120, the separated electrons (e⁻¹) can be brought into contact with heavy metal ions dissolved into water.

Moreover, a water passing rate in the activated carbon filtration part 130 should be lower than that in the ionization part 120 according to the present invention since this helps to provide a sufficient contact time between the separated electrons and the heavy metal ions by securing an enough residence time of the separated electrons (e⁻¹) and the heavy metal ions dissolved into water.

Furthermore, tap water passing through the activated carbon filtration part 130 necessarily passes through a small space between granular activated carbon and silver activated carbon particles in the present invention. There is an advantage in that such a small space sufficiently provides a space in which electrons (e⁻¹) are brought into contact with cations of heavy metals dissolved into water.

In the present invention, heavy metal ions existing in the water are reduced by the electrons (e⁻¹) in a process where the water passes through the activated carbon filtration part 130, which is represented by the following expressions (H) and (III):

Bivalent heavy metal ion (M⁺²)+2e⁻¹=M (II)

Trivalent heavy metal ion (M⁺³)+3e⁻¹=M (III)

As a result, in the present invention, it can be seen that the activated carbon filtration part 130 performs a function of filtering off microorganisms and impurities dissolved into water and at the same time a function of reducing heavy metal ions dissolved into water to heavy metal components. Particularly, with regard to the latter heavy metal reduction function, it can be seen that the activated carbon filtration part 130 greatly contributes in time and space such that anions produced in the previous step and heavy metal cations dissolved into water are brought into enough contact with each other.

The water purifier 100 according to the present invention comprises a heavy metal removing part 140 connected to the activated carbon filtration part 130 and dissolved into water.

In the present invention, the heavy metal removing part 140 removes heavy metal components dissolved into the tap water, which passes through the activated carbon filtration part 130, therefrom. Although small quantities of the heavy metal components are contained in tap water, the heavy metal components exist in the form of ions, and the ions are reduced into heavy metal components while passing through the ionization part 120 and the activated carbon filtration part 130. The heavy metal components, which are harmful to the human body, include, for example, manganese (Mn), chromium (Cr), mercury (Hg), lead (Pb), and the like. According to the present invention, such heavy metals are removed using its magnetization operation. To this end, the heavy metal removing part 140 includes magnets.

According to the present invention, it is preferable to form the heavy metal removing part 140 by arranging magnets having a magnetization force of 2000 to 5000 Gausses in a circumference of a channel. Although the magnets are not particularly limited, it is preferable to arrange the magnets such that an S pole is formed toward the center of the channel, and an N pole is formed in the outer direction of the channel.

According to the present invention, the heavy metal removing part 140 should be formed under the ionization part 120, and it is preferable that the heavy metal removing part 140 be formed under the activated carbon filtration part 130. This is because the heavy metal components recover magnetism as metals in a state where heavy metal ions (M⁺²) dissolved into water are reduced to heavy metal components (M), and the magnetism-recovered heavy metal components can be removed in the heavy metal removing part 140.

The water purifier 100 according to the present invention comprises a discharge part 112 for discharging heavy metal component-removed water to the outside. It is preferable to form the discharge part 112 on top of a body part 114 having the ionization part 120, the activated carbon filtration part 130, and the heavy metal removing part 140 therein.

In the present invention, the discharge part 112 means an outlet from which water that is completely subjected to the water purification process is finally discharged. Here, the discharge part 112 may be a distal end part formed on the body part 114 of the water purifier 100, or a distal end part which is connected to a distal end part of the water purifier and from which a user receives purified water.

In the present invention, it is preferable to coat inner and outer surfaces of the discharge part 112 with silver oxide (AgO), and particularly, to coat the inner surface of the discharge part with silver oxide. Since the discharge part 112, which is an outlet for allowing purified water to be finally discharged therethrough, is exposed to air, the discharge part is exposed to various microorganisms floating in air. Furthermore, the discharge part 112 provides an appropriate environment in which microorganisms take root and live since water is not discharged from the discharge part when the water purifier 100 is not used although water is discharged from the discharge part when the water purifier 100 is used. Therefore, the discharge part 112 becomes a space in which microorganisms such as bacteria live as time goes on, and is responsible for causing the water purifier 100 itself to degenerate into an unhygienic contaminated household appliance. Therefore, considering such unhygienic aspects, the present invention provides no place for the microorganisms to live from the beginning by coating the discharge part 112 with a silver (Ag) component.

Preferably, the water purifier 100 according to the present invention further comprises a mineral supplying part 150 connected to the heavy metal removing part 140.

According to the present invention, the mineral supplying part 150 can be arranged in front or rear of the heavy metal removing part 140. However, it is more preferable to arrange the mineral supplying part 150 in the rear of the heavy metal removing part 140 in order to remove various heavy metal components harmful to the human body from tap water and then elute various mineral components useful to the human body into the water.

In the present invention, the mineral supplying part 150 preferably comprises a germanium ore layer 152 having an ion exchange capability of calcium (Ca), magnesium (Mg), sodium (Na), and so on that are contained in water and are useful to the human body. It is preferable that the germanium ore layer 152 comprise natural germanium ore crushed to have a size of a diameter of 1.0 to 5.0 mm. Furthermore, it is preferable to use the germanium ore after being heated at a temperature of 200 to 300° C. for 2 to 6 hours and cooled slowly. When the germanium ore is used after being heated and cooled under above conditions, microorganisms that may live in the germanium ore itself can be annihilated and the ion exchange capability of the germanium ion can be more improved at the same time.

In the present invention, although it is preferable to arrange the germanium ore layer 152 in the rear of the heavy metal removing part 140, a portion of the germanium ore layer can be formed in a central part of the heavy metal removing part 140 in connection to an arrangement of the water purifier. This is to remove the heavy metal components having magnetism in water using the magnets by hindering the water from flowing and thus reducing the flow rate of the water in such a manner that the central part of the heavy metal removing part 140 is formed not to be hallow but to have a portion of the germanium ore layer 152 formed therein.

In the present invention, it is preferable that the mineral supplying part further comprises a granite layer 154. The granite layer 154 also elutes mineral components useful to the human body into water. Particularly, the granite layer 154 elutes water-soluble minerals, e.g., carbonic acid type ionic minerals, such as Ca(HCO₃)₂, Mg(HCO₃)₂, and KHCO₃, into water, thereby gradually converting tap water passing through the granite layer 154 into weak alkaline water.

In the present invention, the granite layer 154 preferably includes natural granite ore crushed to have a size of a diameter of 1.0 to 5.0 mm. Furthermore, it is preferable to use the granite ore after being heated at a temperature of 400 to 600° C. for 8 to 14 hours and cooled slowly. When the granite ore is used after being heated and cooled under above conditions, microorganisms that may live in the granite ore itself can be annihilated and the water-soluble mineral emitting capability of granite ore can be more improved at the same time.

According to the present invention, the mineral supplying part 150 can additionally remove iron (Fe) component that has not been removed yet in the heavy metal removing part 140.

The water purifier 100 according to the present invention may be used in the following method.

The water purifier 100 according to the present invention is connected to a water pipe 10 and allows an ionization step of ionizing tap water to be performed (S110). While the introduced tap water passes through the ionization part 110, the tap water causes friction with the metal component formed in the ionization part, and the metal component is ionized by the friction. Here, the metal component means a metal having a higher ionization tendency as compared with iron (Fe), and more preferably means zinc (Zn) that can exist as the metal component. The availability of the zinc component has been described above in detail.

Next, in the water purifier 100 according to the present invention, a filtration step is performed (S120). In the filtration step of the present invention, the ionized water is filtered by the activated carbon filtration part 130 while flowing at a flow rate slower than that in the ionization step. Here, residual chlorine and impurities existing in the tap water are removed by granular activated carbon, and microorganisms and the like existing in the tap water are sterilized and removed by silver activated carbon. Furthermore, in the filtration step, electrons separated from zinc ions come into well contact with heavy metal cations existing in water, thereby converting the heavy metal ions into heavy metal components.

After the filtration step is completed in the water purifier 100 according to the present invention, a heavy metal removing step of removing heavy metal components existing in water using magnetism of the heavy metal removing part 140 in a process where the filtered water passes through the heavy metal removing part 140 is performed (S130). In the present invention, the heavy metal components include, for example, manganese (Mn), chromium (Cr), mercury (Hg), lead (Pb) and the like that are harmful to the human body, and the heavy metal components are removed by arranging magnets with a magnetism of 2000 to 5000 Gausses in a circumference of a channel through which the water flows and pulling heavy metals in water to the magnets using the magnetism. Although the magnets are not particularly limited, it is preferable to arrange the magnets such that an S pole is formed toward the center of the channel and an N pole is formed in the outer direction of the channel.

In the water purifier 100 according to the present invention, after the heavy metal removing step is performed, it is more preferable to further include a mineral supplying step of supplying mineral components to the heavy metal-removed water (S140). In the present invention, the mineral components are supplied by the mineral supplying part 150, and the mineral supplying step may be performed by the germanium ore layer 152 and the granite layer 154 as described above.

### Example

Tap water was allowed to pass through the inflow part 110 and to flow into the ionization part 120 in which zinc (Zn) with a higher ionization tendency was embedded. Subsequently, after allowing the tap water to flow into the activated carbon filtration part 130 with a large diameter, residual chlorine, impurities and the like were filtered off. The activated carbon filtration part 130 containing a mixture of 320 g of granular activated carbon and 80 g of silver activated carbon was placed under the body of the water purifier. Heavy metal components that might exist in the tap water were removed in a process of allowing the tap water, from which the residual chlorine and impurities had been filtered, to pass through a heavy metal removing part 140. At this time, magnets with a magnetism of 3000 Gausses were used in the heavy metal removing part 140, wherein four magnets were disposed such that an S pole is directed inward. Subsequently, the heavy metal-removed tap water was discharged to the discharge part 112 via the mineral supplying part 150.

The water quality analyzing process was performed on purified tap water that had passed through the foregoing processes and non-purified tap water that had not passed through the processes, and the water quality analysis results were obtained as follows.

TABLE 1
Table of Water Quality Analysis Result

| Items | Standards | Before water purification | After water purification | Remarks |
|---|---|---|---|---|
| General | 100 CFU/ml | 80 | 0 | Completely |
| bacteria | | | | removed |
| Fecal coliform | Non-detection/100 ml | Non-detection | Non-detection | — |
| Hardness | 300 mg/l | 62 | 60 | — |
| Zinc | 1.0 mg/l or less | 0.402 | 0.406 | — |
| Evaporation | 500 mg/l or less | 123 | 118 | Substantially |
| residues | | | | reduced |
| Manganese | 0.3 mg/l or less | 0.198 | Non-detection | Completely |
| | | | | removed |
| Boron | 0.3 mg/l or less | 0.03 | Non-detection | Completely |
| | | | | removed |
| Iron | 0.3 mg/l or less | Non-detection | Non-detection | — |
| Taste | Tasteless | Tasteless | Tasteless | — |

As discussed above, since tap water was used as test samples, it can be seen from the tests that general bacteria was completely removed and manganese and boron components that are kinds of heavy metals were also removed completely although initial contamination degrees of the tap water were not severe.

Although a water purifier directly connected to a faucet according to the present invention has been specifically described, only the most preferred embodiment of the present invention has been described. The present invention is not limited thereto, but the scope of the present invention is determined and defined by the appended claims. In addition, it will be apparent by those skilled in the art that various changes and modifications can be made thereto without departing from the technical spirit and scope of the present invention.

### INDUSTRIAL APPLICABILITY

A water purifier directly connected to a faucet according to the present invention can be used at households or offices in a state where the water purifier is directly connected to tap water, and the water purifier removes microorganisms and heavy metal components contaminated in water and supplies mineral components to the water at the same time.

1. A water purifier directly connected to a faucet, comprising:
an inflow part 110 connected to a water pipe and allowing tap water to be introduced thereinto;
an ionization part 120 using a metal selected from the group consisting of magnesium (Mg), aluminum (Al), and zinc (Zn) having a higher ionization tendency as compared with iron (Fe) and ionizing the metal having a higher ionization tendency to dissolve the metal into the tap water;
an activated carbon filtration part 130 connected to the ionization part and filtering the tap water while the activated carbon filtration part allows the tap water to flow at a flow rate slower than that in the ionization part;
a heavy metal removing part 140 connected to the activated carbon filtration part and removing heavy metal components into which heavy metal ions are converted by action of the ionization part; and
a discharge part 112 for discharging heavy metal component-removed tap water to the outside.

2. The water purifier as claimed in claim 1, further comprising a mineral supplying part 150 connected to the heavy metal removing part and supplying mineral components to the tap water after removing the heavy metal components from the tap water.

3. The water purifier as claimed in claim 1, wherein the metal having a higher ionization tendency used in the ionization part 120 is zinc (Zn).

4. The water purifier as claimed in claim 1, wherein the discharge part 112 has an inner surface coated with silver oxide (AgO).

5. The water purifier as claimed in claim 2, wherein the mineral supplying part 150 comprises a germanium ore layer 152 including germanium ore having a size of a diameter of 1.0 to 5.0 mm.

6. The water purifier as claimed in claim 5, wherein the mineral supplying part 150 further comprises a granite layer 154, the granite layer 154 including granite ore crushed to have a size of a diameter of 1.0 to 5.0 mm, the granite ore being used after being heated at a temperature of 400 to 600° C. for 8 to 14 hours and cooled slowly.

7. A method of using a water purifier directly connected to a faucet, comprising:
an ionization step of introducing tap water from a water pipe into the water purifier, and using a metal selected from the group consisting of magnesium (Mg), aluminum (Al), and zinc (Zn) having a higher ionization tendency as compared with iron (Fe) in the introduced tap water to dissolve cationized metal ions and anionized electrons (e) into the tap water by ionizing the metal having a higher ionization tendency;
a filtration step of filtering the ionized water by activated carbon while the ionized water flows slowly as compared with the ionization step;
a heavy metal removing step of reacting the electrons (e) and heavy metal ions existing in water with each other in the filtered water to produce heavy metal components, and removing the produced heavy metal components by magnets; and
a discharge step of discharging heavy metal component-removed water to the outside to use it as drinking water.

8. The method as claimed in claim 7, wherein the filtration step is performed by reacting electrons (e⁻¹) newly supplied into the water in the ionization step and heavy metal ions that has already been dissolved into the water with each other to reduce the heavy metal ions into heavy metal components in the form of the followings:
bivalent heavy metal ion (M⁺²)+2e⁻¹=M; or
trivalent heavy metal ion (M⁺³)+3e⁻¹=M.

9. The method as claimed in claim 8, wherein the filtration step is performed by filtering the tap water and reducing the heavy metal ions into heavy metal components at the same time, and the heavy metal removing step is performed by removing the reduced heavy metal components by magnets having a magnetism of 2000 to 5000 Gausses.

10. The method as claimed in claim 9, further comprising a mineral supplying step of supplying mineral components into the water after the heavy metal removing step.
